(19) United States
(12) Patent Application Publication
(10) Pub. No.: US 2015/0268765 A1
(43) Pub. Date: Sep. 24, 2015

(54) INPUT DEVICE AND DISPLAY DEVICE HAVING TOUCH SENSOR FUNCTION

(71) Applicant: Panasonic Intellectual Property Management Co., Ltd., Osaka (JP)

(72) Inventors: Takahito NAKAYAMA, Osaka (JP); Hiroyuki KADO, Osaka (JP); Toshiyuki AOYAMA, Osaka (JP); Shigeo KASAHARA, Hyogo (JP); Naoki KOSUGI, Kyoto (JP); Shuji INOUE, Osaka (JP); Manabu INOUE, Osaka (JP); Akira TOKAI, Hyogo (JP); Kazushige TAKAGI, Osaka (JP)

(21) Appl. No.: 14/645,755

(22) Filed: Mar. 12, 2015

(30) Foreign Application Priority Data
Mar. 20, 2014 (JP) 2014-057471
Mar. 3, 2015 (JP) 2015-41793

(51) Int. Cl. G06F 3/044

(52) U.S. Cl. CPC G06F 3/044

(57) ABSTRACT

An input device having a touch sensor function includes a plurality of first electrodes; a plurality of second electrodes which are disposed facing the plurality of first electrodes, each second electrode coupled capacitively with the first electrode to output a detection signal based on a touch operation, a plurality of third electrodes each disposed in a region between adjacent second electrodes, and a plurality of first connection sections which have a resistance value not lower than 1 MΩ, and electrically connect the plurality of third electrodes to a predetermined electrode set to a predetermined potential.

### BACKGROUND

1. Technical Field

The present disclosure relates to an input device and a display device which have a touch sensor function of inputting coordinates (touched position) by a touch operation on a screen.

2. Related Art

A display device, which is provided with an input device having an input function of inputting information by a touch operation on a display screen with user's finger or the like, has been employed in a mobile electronic apparatuses such as a PDA and a mobile phone, a variety of home appliances, and stationary customer's guidance terminals such as an unmanned reception machine. As a touch detection type in such an input device by a touch operation, there are known a resistance film touch panel for detecting a change in resistance at a touched portion, a capacitive touch panel for detecting a change in capacitance, an optical sensor type touch panel for detecting a change in amount of light at a portion shaded by a touch, and some other system.

The capacitive touch panel has an advantage as follows compared with the resistance film touch panel and the optical sensor type touch panel. For example, the resistance film touch panel and the optical sensor type touch panel have lower transmittances such as 80%. In contrast, the capacitive touch panel has higher transmittance such as about 90%, thus not making display quality deteriorate. Further, in the resistance film touch panel, a touched position is detected by mechanical contact of a resistance film, and thus the resistance film might be degraded or damaged. In contrast, the capacitive touch panel has no mechanical contact such as contact of a detecting electrode with another electrode or the like, and is also advantageous in terms of durability.

### SUMMARY

There are cases where static electricity may be applied to a device in manufacturing process of an electronic device or at the time of its use by a user. Specifically, static electricity is applied when a screen is touched with a finger or a protective film for a polarizing plate is peeled off in the manufacturing process. By accumulation of electric charges on the polarizing plate or the like due to this static electricity, orientation disorder of liquid crystal molecules might occur to bring about disturbance in display of the liquid crystal display. Moreover, in the case of disposing a floating electrode (dummy electrode) for improving the visibility, accumulation of electric charges in this floating electrode may cause the disturbance in the display to further increase. Hence it is required to provide the floating electrode with measures against electrostatic discharge (ESD). Japanese Patent Application Laid-Open No. 2012-063839 discloses a technique of forming a high-resistance conductive layer above a detection electrode to release applied static electricity.

The present disclosure has an object to provide an input device and a display device which have a touch sensor function capable of reducing disturbance in display on occurrence of static electricity.

In a first aspect, an input device having a touch sensor function is provided. The input device includes a plurality of first electrodes; a plurality of second electrodes which are disposed facing the plurality of first electrodes, each second electrode coupled capacitively with the first electrode to output a detection signal based on a touch operation; a plurality of third electrodes each disposed in a region between adjacent second electrodes; and a plurality of first connection sections which have a resistance value not lower than 1 MΩ, and electrically connect the plurality of third electrodes to a predetermined electrode set to a predetermined potential.

In a second aspect, a display device is provided. The display device includes a display unit configured to update a display by applying scanning signals to a plurality of scanning signal lines in one frame period; and the above input device which detects the touched position in a period synchronous with a period for updating the display.

According to the present disclosure, it is possible to provide an input device and a display device which have a touch sensor function capable of reducing corruption of a display at the time of generation of static electricity.

### BRIEF DESCRIPTION OF DRAWINGS

FIG. 1 is a block diagram for explaining a whole configuration of a liquid crystal display device provided with a touch sensor function according to an embodiment of the present disclosure;

FIG. 2A is a perspective view showing an example of an arrangement of driving electrodes and detection electrodes which constitute a touch sensor;

FIG. 2B is a view for explaining arrangement of the driving electrodes, the detection electrodes and pixel electrodes;

FIGS. 3A and 3B are explanatory views for explaining a schematic configuration and an equivalent circuit of a touch sensor in the state of not performing a touch operation and the state of performing the touch operation;

FIG. 4 is an explanatory diagram showing changes in detection signal in the case of not performing the touch operation and in the case of performing the touch operation;

FIG. 5 is a schematic view showing an arrangement of the scanning signal lines in the liquid crystal panel and arrangements of the driving electrodes and the detection electrodes in the touch sensor;

FIGS. 6A to 6F are explanatory views showing an example of the relation between input of scanning signals to a line block of the scanning signal lines for updating a display of the liquid crystal panel and supply of driving signals to a line block of the driving electrode for detecting a touch in the touch sensor;

FIG. 7 is a timing chart showing the state of applying the scanning signals and the driving signals in one horizontal scanning period;

FIG. 8 is a timing chart for explaining an example of the relation between a display update period and a touch detection period in the one horizontal scanning period;

FIG. 9A is a view for explaining arrangement of a ground electrode;

FIG. 9B is a view (plan view) showing an example of arrangement of electrodes and connection sections of a liquid crystal display device in a first embodiment;

FIG. 10 is a sectional view cut along a line A-A of the structure shown in FIG. 9B;

FIGS. 11A and 11B are diagrams for explaining an electric field generated between the driving electrode 11 and the electrode 13;

FIG. 12 is a plan view showing another example of an arrangement of the electrodes and the connection sections of the display device having the touch sensor function in the first embodiment;

FIG. 13 is a plan view showing another example of the arrangement of the electrodes and the connection sections of the display device having the touch sensor function in the first embodiment;

FIG. 14 is a plan view showing an example of an arrangement of the electrodes and the connection sections of the display device having the touch sensor function in a second embodiment;

FIG. 15 is a sectional view cut along a line B-B of the structure shown in FIG. 14; and

FIG. 16 is a plan view showing another example of the arrangement of the electrodes and the connection sections of the display device having the touch sensor function in the second embodiment.

### DETAILED DESCRIPTION OF PREFERRED EMBODIMENTS

Hereinafter, as an example of an input device according to an embodiment of the present technique, a touch sensor used for a liquid crystal display device will be described using the drawings, but the present technique can be used for another display device such as an EL display device, and is thus not restricted to this example.

### First Embodiment

### 1-1. Configuration

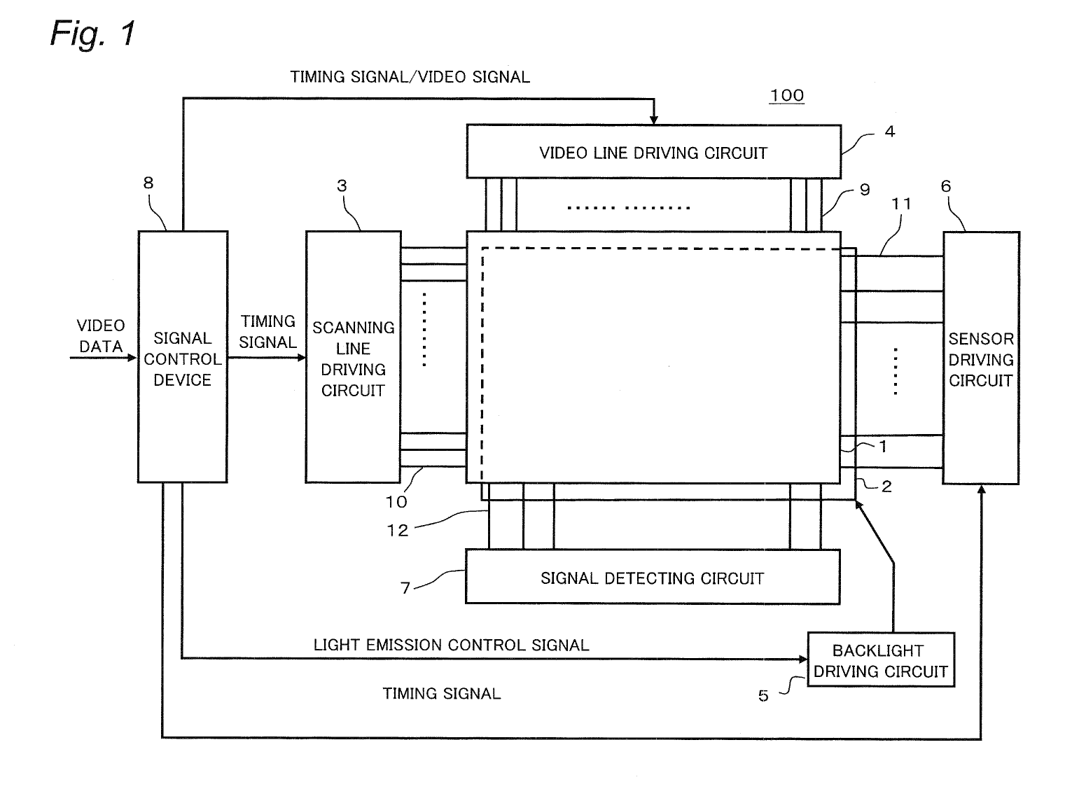

FIG. 1 is a block diagram for explaining a whole configuration of a liquid crystal display device 100 having a touch sensor function according to a first embodiment. As shown in FIG. 1, the liquid crystal display device 100 is provided with a liquid crystal panel (touch panel) 1, a backlight unit 2, a scanning line driving circuit 3, a video line driving circuit 4, a backlight driving circuit 5, a sensor driving circuit 6, a signal detecting circuit 7, and a signal control device 8.

The liquid crystal panel 1 has a rectangular planar shape, and has a TFT substrate that is made of a transparent substrate such as a glass substrate, and a counter substrate that is disposed facing the TFT substrate to form a predetermined space with the TFT substrate. A liquid crystal material is filled in a space between the TFT substrate and the counter substrate.

The TFT substrate is located on the rear surface side of the liquid crystal panel 1. On a substrate making the TFT substrate, there are formed pixel electrodes disposed two dimensionally, thin film transistors (TFT) as switching elements which are provided corresponding to the pixel electrodes and perform on/off control of applying a voltage to the pixel electrodes, common electrodes, and the like. Although not shown, a ground electrode is disposed around the plurality of pixel electrodes disposed two dimensionally.

Further, the counter substrate is located on the front surface side of the liquid crystal panel 1. On a transparent substrate making the counter substrate, there are formed a color filter (CF) which is made up of at least three primary colors, red (R), green (G) and blue (B), in a position corresponding to the pixel electrode, a black matrix (BM) which is made of a shading material for improving contrast and disposed between each RGB subpixels and/or between each pixel made up of the RGB subpixels, and the like. It is to be noted that in the present embodiment, a description will be given assuming that the TFT formed in each subpixel of the TFT substrate is an n-channel TFT.

On the TFT substrate, a plurality of video signal lines 9 and a plurality of scanning signal lines 10 are formed mostly orthogonal to each other. The scanning signal line 10 is provided on each horizontal column of the TFTs, and commonly connected to gate electrodes of a plurality of TFTs on the horizontal column. The video signal line 9 is provided on each vertical row of the TFTs, and commonly connected to drain electrodes of a plurality of TFTs on the vertical row. Further, a source electrode of each TFT is connected with the pixel electrode disposed in a pixel region corresponding to the TFT.

An on/off operation of each TFT formed on the TFT substrate is controlled by a predetermined unit in accordance with a scanning signal applied to the scanning signal line 10. Each TFT controlled to be on in a horizontal column sets the pixel electrode to a potential (pixel voltage) in accordance with a video signal applied to the video signal line 9. The liquid crystal panel 1 has a plurality of pixel electrodes and the common electrode facing the pixel electrodes. The liquid crystal panel 1 controls an orientation of liquid crystal with respect to each pixel region by means of an electric field generated between the pixel electrode and the common electrode, to change a transmittance to light incident from the backlight unit 2, thereby forming an image on a display surface.

The backlight unit 2 is arranged on the rear surface side of the liquid crystal panel 1 and emits light from the rear surface of the liquid crystal panel 1. For example, as a backlight unit, there are known one having a structure where a plurality of light-emitting diodes are arrayed to constitute a surface light source, and one having a structure where light of the light-emitting diode is used together with a light-guiding plate and a diffused reflection plate to serve as a surface light source.

The scanning line driving circuit 3 is connected to the plurality of scanning signal lines 10 formed on the TFT substrate. The scanning line driving circuit 3 sequentially selects the scanning signal line 10 in accordance with a timing signal inputted from the signal control device 8, and applies a voltage for turning on the TFT to the selected scanning signal line 10. For example, the scanning line driving circuit 3 is configured including a shift register. The shift register starts an operation upon receipt of a trigger signal from the signal control device 8, sequentially selects the scanning signal line 10 along a vertical scanning direction, and outputs a scanning pulse to the selected scanning signal line 10.

The video line driving circuit 4 is connected to the plurality of video signal lines 9 formed on the substrate. The video line driving circuit 4 applies a voltage corresponding to a video signal indicating a grayscale value of each subpixel to each TFT which is connected to the selected scanning signal line 10 based on selection of the scanning signal line 10 by the scanning line driving circuit 3. Thereby, the video signal is written in the subpixel corresponding to the selected scanning signal line 10.

The backlight driving circuit 5 drives the backlight unit 2 to emit light at timing and with luminance corresponding to a light emission control signal inputted from the signal control device 8.

The liquid crystal panel (touch panel) 1 of the liquid crystal display device 100 is an in-cell type liquid crystal panel, and adopts a capacitive touch sensor. The touch sensor includes a plurality of driving electrodes 11 (an example of the first electrodes) and a plurality of detection electrodes 12 (an example of the second electrodes). The plurality of driving electrodes 11 and the plurality of detection electrodes 12 as the electrodes included in the touch sensor are disposed intersecting with each other in the liquid crystal panel 1.

The touch sensor including these driving electrodes 11 and detection electrodes 12 detects a response to an input electric signal with a change in capacitance between the driving electrode 11 and the detection electrode 12 to detect contact (touch) of an object with the display surface. As electric circuits for detecting this response, the sensor driving circuit 6 and the signal detecting circuit 7 are provided.

The sensor driving circuit 6 is an alternating current (AC) signal source, and is connected to the driving electrode 11. For example, the sensor driving circuit 6 receives a timing signal from the signal control device 8, sequentially selects the driving electrode 11 in synchronization with an image display of the liquid crystal panel 1, and supplies a driving signal Txv as a rectangular pulse voltage to the selected driving electrode 1. For example, similarly to the scanning line driving circuit 3, the sensor driving circuit 6 includes the shift register, makes the shift register operate upon receipt of a trigger signal from the signal control device 8, selects the driving electrode 11 in the sequence along a vertical scanning direction, and supplies the selected driving electrode 11 with a driving signal Txv as a pulse voltage.

It is to be noted that the driving electrodes 11 and the scanning signal lines 10 are formed on the TFT substrate so that the electrodes 11 and the scanning signal lines 10 extend in a horizontal column direction, and a plurality of electrodes 11 and the scanning signal lines 10 are arrayed in a vertical row direction. The sensor driving circuit 6 and the scanning line driving circuit 3 electrically connected to the driving electrodes 11 and the scanning signal lines 10 are disposed on both sides of a width direction (horizontal direction) of a display region where the subpixels are arrayed. In the example of FIG. 1, the scanning line driving circuit is disposed on one side of the width direction (horizontal direction) of the display region and the sensor driving circuit 6 is disposed on the other side thereof, but those circuits may be disposed in the opposite positional relation. Further, the scanning line driving circuit 3 and the sensor driving circuit 6 may be disposed in another region by use of wiring around the panel, or the like.

The signal detecting circuit 7 is a detection circuit for detecting a change in electrostatic capacitance, and connected to the detection electrode 12. The signal detecting circuit 7 includes detection circuits each of which is provided for each detection electrodes 12, and outputs a detection signal Rxv as a change in capacitance detected in the detection electrode 12. It is to be noted that as another constitutional example, one detection circuit may be provided for each of a plurality of groups of detection electrodes 12. Then, the detection signal Rxv may be detected and outputted in a time-division manner for each of the plurality of groups of detection electrodes 12 in response to a plurality of times of applying of pulse voltages to the driving electrode 11.

A touch (contact) position of the object on the display surface is found based on a result of determining, by the sensor control circuit (not shown), to which driving electrode 11 the driving signal Txv is applied and in which detection electrode 12 a signal generated due to the touch (contact) is detected at the time of the application. An intersection between the driving electrode 11 to which the driving signal Txv has been applied and the detection electrode 12 in which the detection signal Rxv has been obtained are obtained as the touch (contact) position by computing. It should be noted that as the computing method for finding the touch (contact) position, there are a method for finding it by providing an operation circuit in the liquid crystal display device, and a method for finding it by an operation circuit outside the liquid crystal display device.

The signal control device 8 is provided with an arithmetic processing circuit such as a CPU and memories such as a ROM and a RAM. The signal control device 8 performs a variety of image signal processing such as color adjustment based on inputted video data, to generate a pixel signal indicating a grayscale value of each subpixel, and supplies it to the video line driving circuit 4. Further, based on the inputted video data, the signal control device 8 generates a timing signal for synthesizing an operation and supplies it to each of the scanning line driving circuit 3, the video line driving circuit 4, the backlight driving circuit 5, the sensor driving circuit 6 and the signal detecting circuit 7. Moreover, as the light emission control signal to the backlight driving circuit 5, the signal control device 8 supplies a luminance signal for controlling luminance of the light-emitting diode based on the inputted video data.

Here, the scanning line driving circuit 3, the video line driving circuit 4, the sensor driving circuit 6, and the signal detecting circuit 7, which are connected to each signal line and electrode in the liquid crystal panel 1, are each configured by mounting a semiconductor chip(s) of each circuit on a flexible circuit board, a printed circuit board or a glass substrate. However, the scanning line driving circuit 3, the video line driving circuit and the sensor driving circuit 6 may be formed on the TFT substrate simultaneously with the TFT and the like.

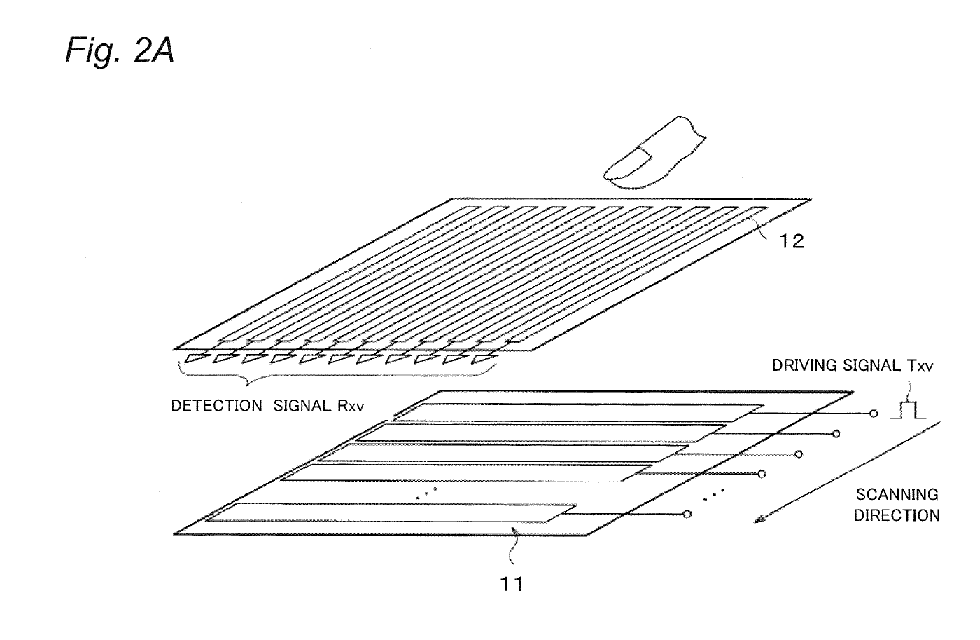

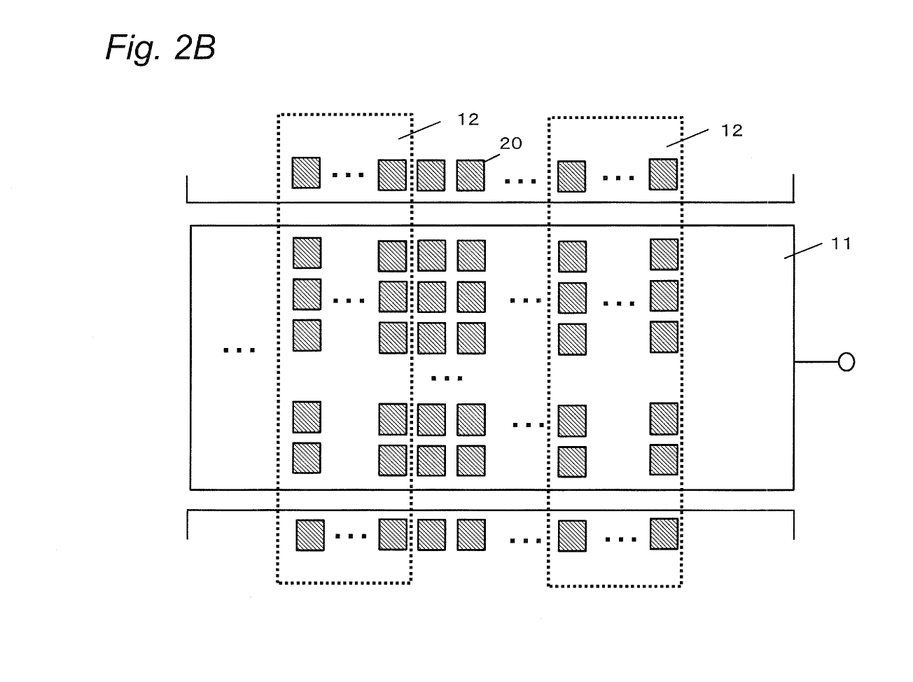

FIG. 2A is a view showing an example of an arrangement of the driving electrodes and the detection electrodes which are included in the touch sensor. As shown in FIG. 2A, the touch sensor as the input device is composed of a plurality of driving electrodes 11 as rectangular-shaped electrode extending in the horizontal direction (crosswise direction of FIG. 2A), and a plurality of detection electrodes 12 as substantially striped electrode patterns (conductors) extending in a direction intersecting with the extending direction of the conductors of the driving electrodes 11. A capacitive element having electrostatic capacitance is formed at each portion where the driving electrode 11 and the detection electrode 12 intersect with each other.

Further, the driving electrodes 11 are arrayed to extend in a direction parallel to the direction in which the scanning signal lines 10 extend. As described in detail later, the driving electrode 11 is disposed corresponding to each of N (N is a natural number) line blocks with M (M is a natural number) scanning signal lines taken as one line block. The driving electrode 11 applies the driving signal Txv for each like block.

In performing a touch detection operation, the sensor driving circuit 6 supplies the driving signal Txv to the driving electrode 11 so that scanning is sequentially performed in each line block in a time-division control. Thereby, one line block to be detected is sequentially selected. Further, output of the detection signal Rxv from the detection electrode 12 allows touch detection to be performed in one line block.

FIG. 2B is a view for explaining the positional relation among the pixel electrodes 20, the driving electrodes 11 and the detection electrodes 12. The pixel electrodes 20 are disposed with the positional relation to the driving electrodes 11 and the detection electrodes 12 as shown in FIG. 2B.

### 1-2. Operation

1-2-1. Principle of Touch Detection

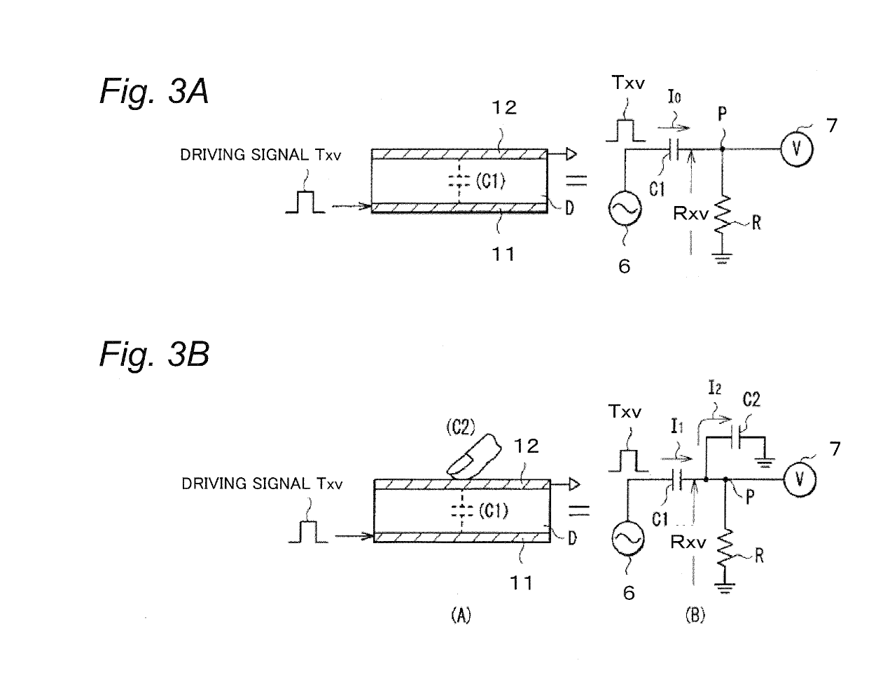

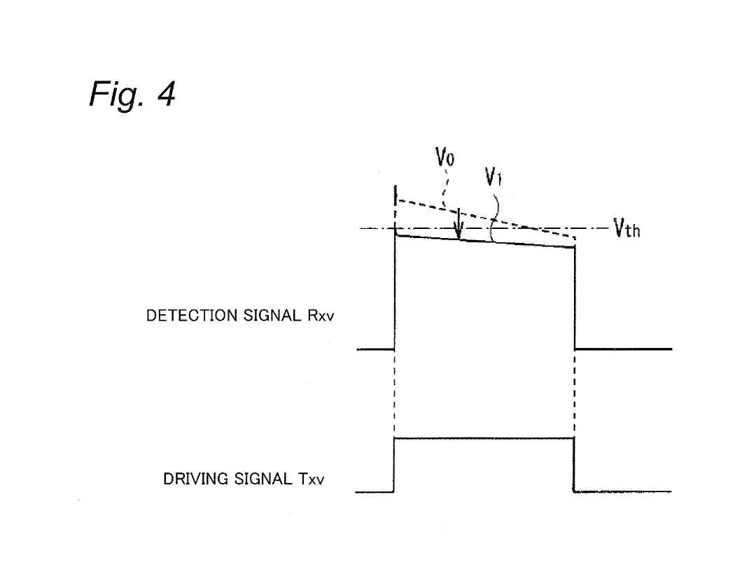

An operation of the liquid crystal display device as thus configured will be described. First, a principle (voltage detection type) of the touch detection in the touch sensor in the input device will be described using FIGS. 3 and 4.

FIGS. 3A and 3B are views explaining schematic configurations and equivalent circuits of the touch sensor in the case of not performing the touch operation (FIG. 3A) and in the state of performing the touch operation (FIG. 3B), respectively. FIG. 4 is a diagram explaining changes in detection signal in the case of not performing the touch operation and in the case of performing the touch operation.

In the capacitive touch sensor, a capacitive element is formed at an intersection (cf. FIG. 2A) between a pair of driving electrode 11 and the detection electrode 12 which are disposed two dimensionally so as to intersect with each other. That is, as shown in FIG. 3A, a capacitive element C1 is configured of the driving electrode 11, the detection electrode 12 and a dielectric D. One end of the capacitive element C1 is connected to the sensor driving circuit 6 as an AC signal source, and the other end P is connected to the signal detecting circuit 7 as a voltage detector while being grounded via a resistor R.

When the driving signal Txv (cf. FIG. 4) of a pulse voltage with a predetermined frequency on the order of several kHz to ten-odd of kHz is applied from the sensor driving circuit 6 as the AC signal source to the driving electrode 11 (one end of the capacitive element C1), an output waveform (detection signal) Rxv as shown in FIG. 4 appears in the detection electrode 12 (the other end P of the capacitive element C1).

In a state where the finger does not come into contact (nor come close), as shown in FIG. 3A, a current I0 in accordance with a capacitance of the capacitive element C1 flows associated with charging/discharging on the capacitive element C1. A potential waveform at the other end P of the capacitive element C1 at this time becomes like a waveform. V0 of the detection signal Rxv shown in FIG. 4, and this is detected by the signal detecting circuit 7 as the voltage detector.

On the other hand, in a state where the finger comes into contact (or come close), as shown in FIG. 3B, the equivalent circuit changes to have a configuration where a capacitive element C2 formed by the finger is added in series to the capacitive element C1. In this state, currents I1 and I2 flow accompanied with charging/discharging on the capacitive elements C1 and C2, respectively. A potential waveform at the other end P of the capacitive element C1 at this time becomes like a waveform V1 of the detection signal Rxv shown in FIG. 4, and this is detected by the signal detecting circuit 7 as the voltage detector. At this time, the potential at the point P is a potential defined by the currents I1 and I2 flowing through the capacitive elements C1 and C2. Hence amplitude of the waveform V1 becomes a smaller than amplitude of the waveform V0 in the non-contact state.

The signal detecting circuit 7 compares a potential of the detection signal outputted from each detection electrode 12 with a predetermined threshold voltage Vth. The signal detecting circuit 7 determines the state as the non-contact state when the potential is not smaller than the threshold voltage, and determines the state as the contact state when the potential is smaller than the threshold voltage. In such a manner, the touch detection can be performed. As the method for sensing a signal of a change in capacitance other than the above method, there are a method for sensing a current, and some other method.

1-2-2. Method for Driving Touch Sensor

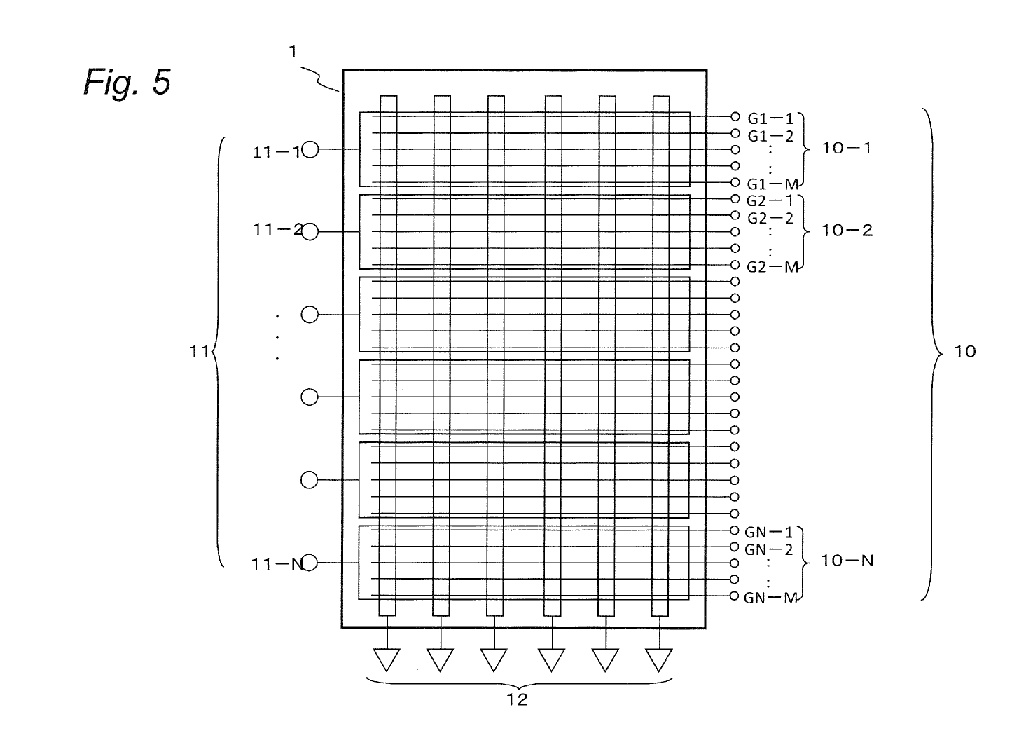

Next, a method for driving a touch sensor in the liquid crystal display device of the present embodiment will be described using FIGS. 5 to 8.

FIG. 5 is a schematic view showing an array structure of the scanning signal lines in the liquid crystal panel and array structures of the driving electrodes and the detection electrodes in the touch sensor. As shown in FIG. 5, the scanning signal lines 10 extending in the horizontal direction are grouped by M (M is a natural number) scanning signal lines Gi-1, Gi-2 . . . Gi-M (i is 1 to N). Each group is managed as one line block. That is, the scanning signal lines 10 are arrayed, divided into N (N is a natural number) line blocks 10-1, 10-2 . . . 10-N.

The driving electrodes 11 in the touch sensor are arrayed such that N driving electrodes 11-1, 11-2 . . . 11-N are extended in the horizontal direction in association with the line blocks 10-1, 10-2 . . . 10-N. A plurality of detection electrodes 12 are arrayed so as to intersect with the N driving electrodes 11-1, 11-2 . . . 11-N.

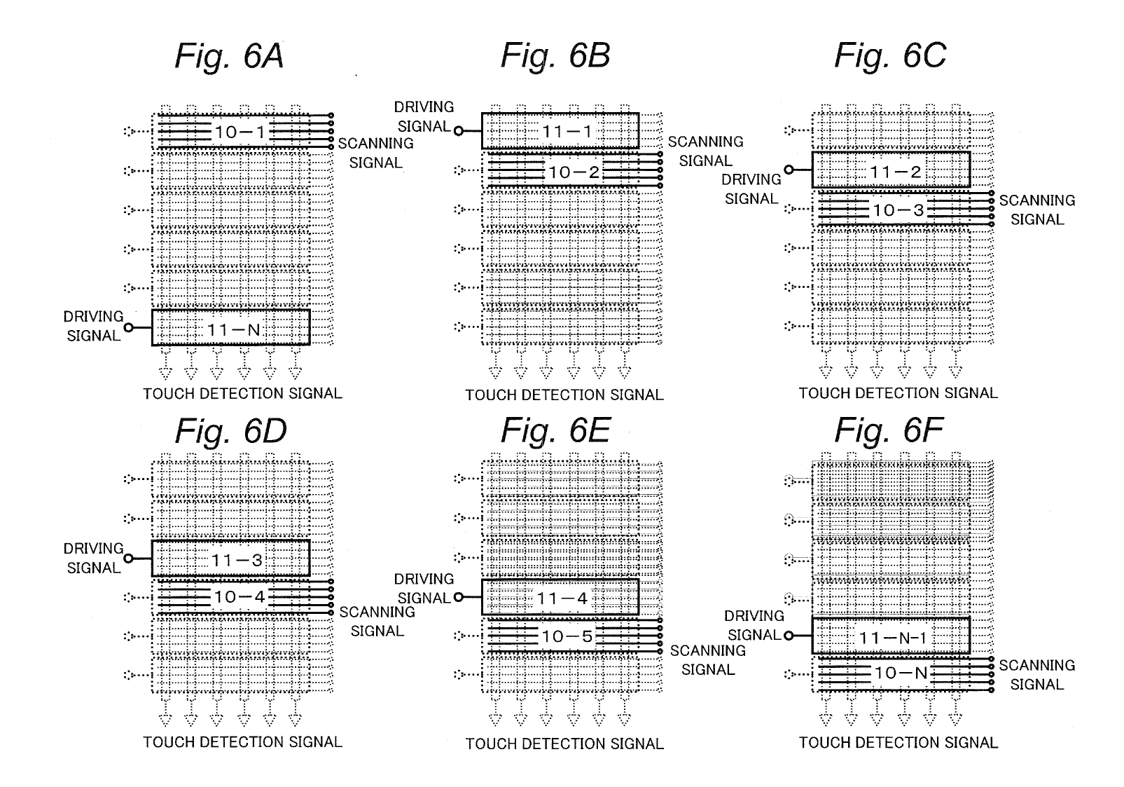

FIG. 6 is an explanatory view showing an example of the relation between input of scanning signals to the line block of the scanning signal lines for updating a display of the liquid crystal panel and supply of a driving signal to the line block of the driving electrode for performing the touch detection in the touch sensor. Each of FIGS. 6A to 6F shows a state in one horizontal scanning period. In the present embodiment, the line block of the scanning signal lines to supply the scanning signals for updating display of the liquid crystal panel is made different from the line block of the driving electrode to supply the driving signal for performing the touch detection in the touch sensor.

Specifically, as shown in FIG. 6A, in a horizontal scanning period when the scanning signal is sequentially inputted to each scanning signal line of the first line block 10-1, the driving signal is supplied to the driving electrode 11-N corresponding to the last line block 10-N. In a horizontal scanning period subsequent thereto as shown in FIG. 6B, the scanning signal is sequentially inputted to each scanning signal line of the second line block 10-2. Further, in that horizontal scanning period, the driving signal is supplied to the driving electrode 11-1 corresponding to the first line block 10-1. In a horizontal scanning period subsequent thereto, as shown in FIG. 6C, the scanning signal is sequentially inputted to each scanning signal line of the third line block 10-3. Further, in that horizontal scanning period, the driving signal is supplied to the driving electrode 11-2 corresponding to the second line block 10-2.

Similarly, as shown in FIGS. 6D to 6F, while the line block is sequentially switched among the line blocks 10-3, 10-4, 10-5 . . . 10-N, the scanning signal is sequentially inputted to each scanning signal line of each line block. Simultaneously, the driving signal is supplied to the driving electrodes 11-3, 11-4, . . . 11-N-1 corresponding to the line blocks 10-3, 10-4, . . . 10-N-1 that are one line before the line blocks 10-4, 10-5 . . . 10-N that supply the scanning signals.

That is, in the present embodiment, regarding the drive signal supplied to the driving electrode 11, in one horizontal scanning period when a display update is performed, the driving electrode 11-i (i=1 to N), which corresponds to a line block where the scanning signals are not being applied to a plurality of scanning signal lines, is selected and the driving signal is supplied thereto.

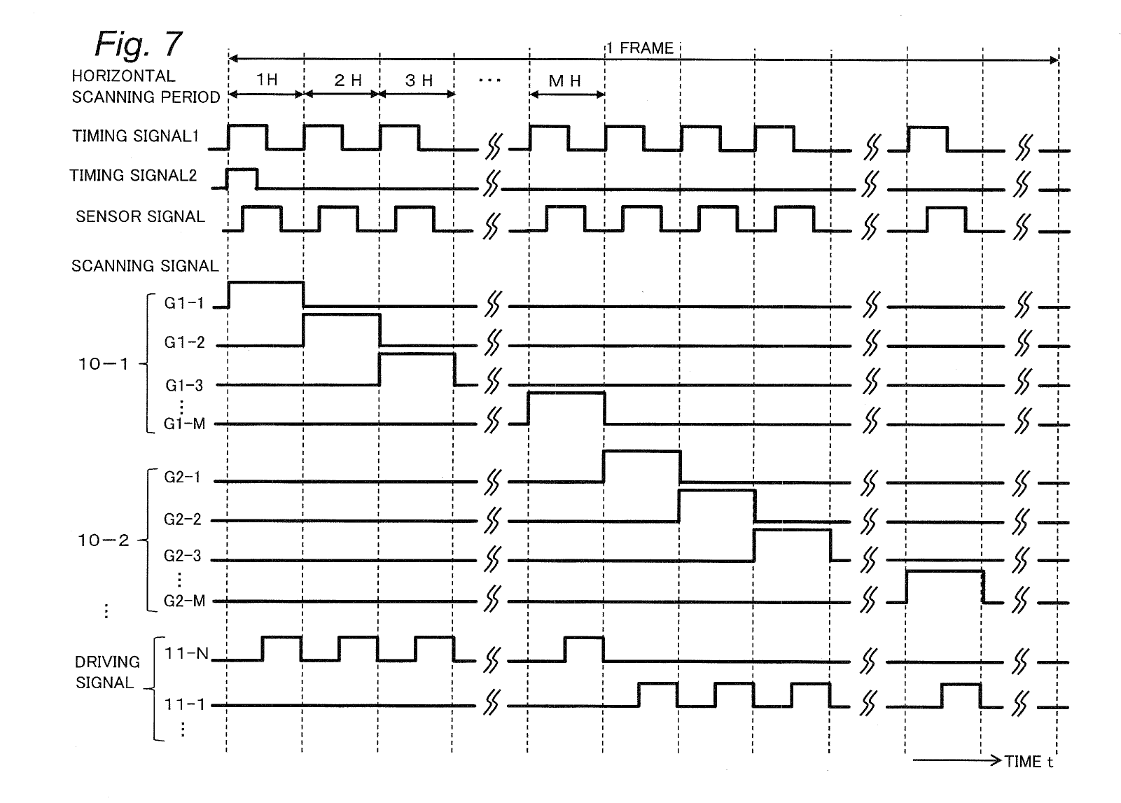

FIG. 7 is a timing chart showing the state of applying the scanning signals and the driving signals in one horizontal scanning period. As shown in FIG. 7, in each horizontal scanning period (1H, 2H, 3H . . . MH) in one frame period, the scanning signal is inputted to the scanning signal line 10 by a line block unit (10-1, 10-2 . . . 10-N), to perform display update. Within this period when the scanning signal is being inputted, the driving signal for the touch detection is supplied to the driving electrode 11-1, 11-2 . . . or 11-N that corresponds to the line block to which the scanning signal is not being inputted.

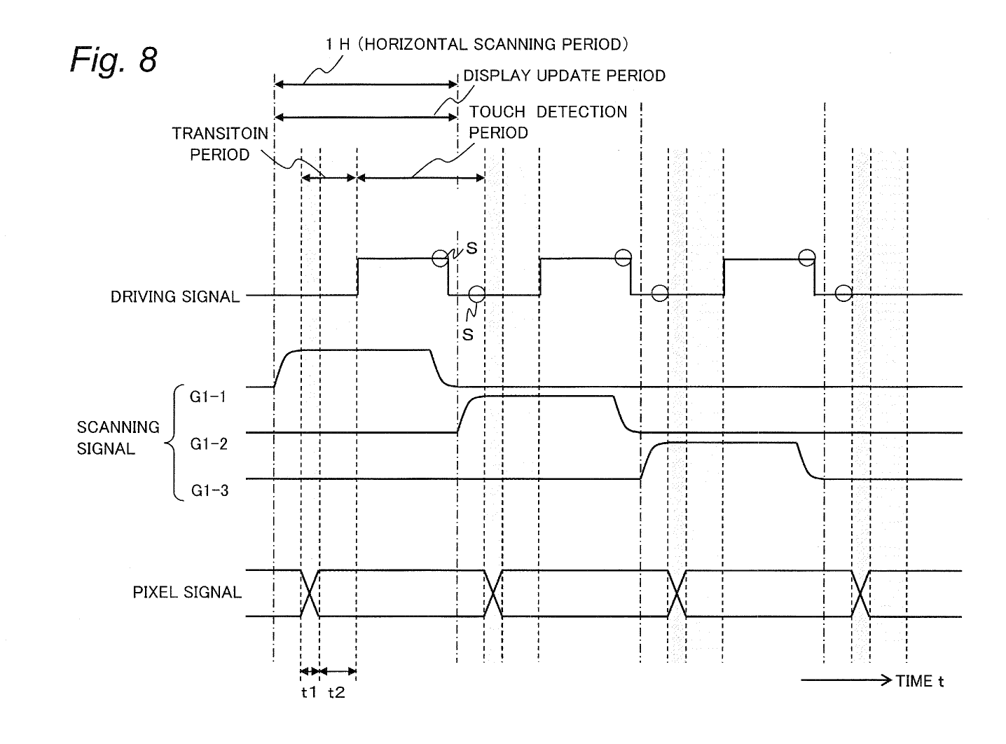

FIG. 8 is a timing chart for explaining an example of the relation between a display update period and a touch detection period in one horizontal scanning period.

As shown in FIG. 8, in each display update period, the scanning signal is inputted to the scanning signal line 10 (G1-1, G1-2, . . . ) while a pixel signal corresponding to the inputted video signal is inputted to the video signal line 9 connected to the switching element of the pixel electrode in each subpixel. It is to be noted that in FIG. 8, in the horizontal scanning period, a transition period exists corresponding to the time until a pulse scanning signal rises to a predetermined potential.

In the present disclosure, a touch detection period is provided at timing in synchronization with the display update period, and a period subsequent to the transition period after the start of the display update period is taken as the touch detection period. That is, when the transition period when the scanning signal rises to the predetermined potential completes, a pulse voltage is supplied as the driving signal to the driving electrode 11, and the touch detection period is started from a point of a potential displacement due to rising of the pulse voltage. Further, touch detection timing S exists at two portions, which are a pulse voltage falling point and an end point of the touch detection period.

It is to be noted that the touch detection operation in the touch detection period is as described using FIGS. 3 and 4. Although one of example of the touch detection timing has been shown here, regarding the touch detection timing, it is desirable to detect a touch at a timing when noise from the liquid crystal display device can be avoided.

Further, although the above description has been given on the assumption of using the in-cell type liquid crystal panel (touch panel), the liquid crystal panel may be one other than the in-cell type and may, for example, be an out-cell type. In the out-cell type liquid crystal panel, synchronization of the scanning line driving circuit and the sensor driving circuit is not necessarily required.

### 1-3. Electrode Structure of Touch Sensor

Next, an electrode structure of the touch sensor in the liquid crystal panel 1 in the present disclosure will be described using the drawings.

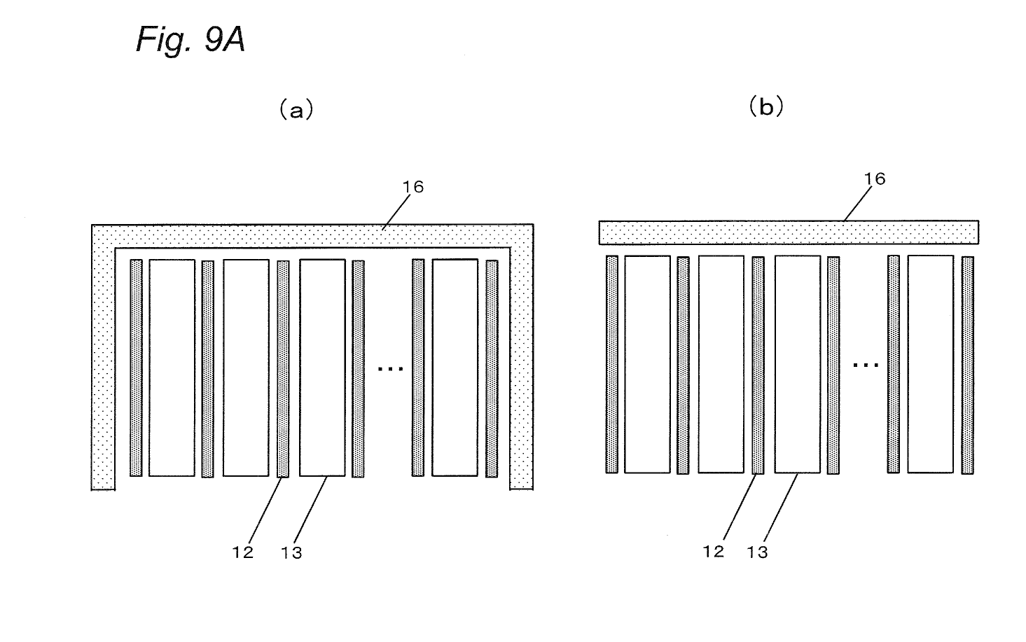

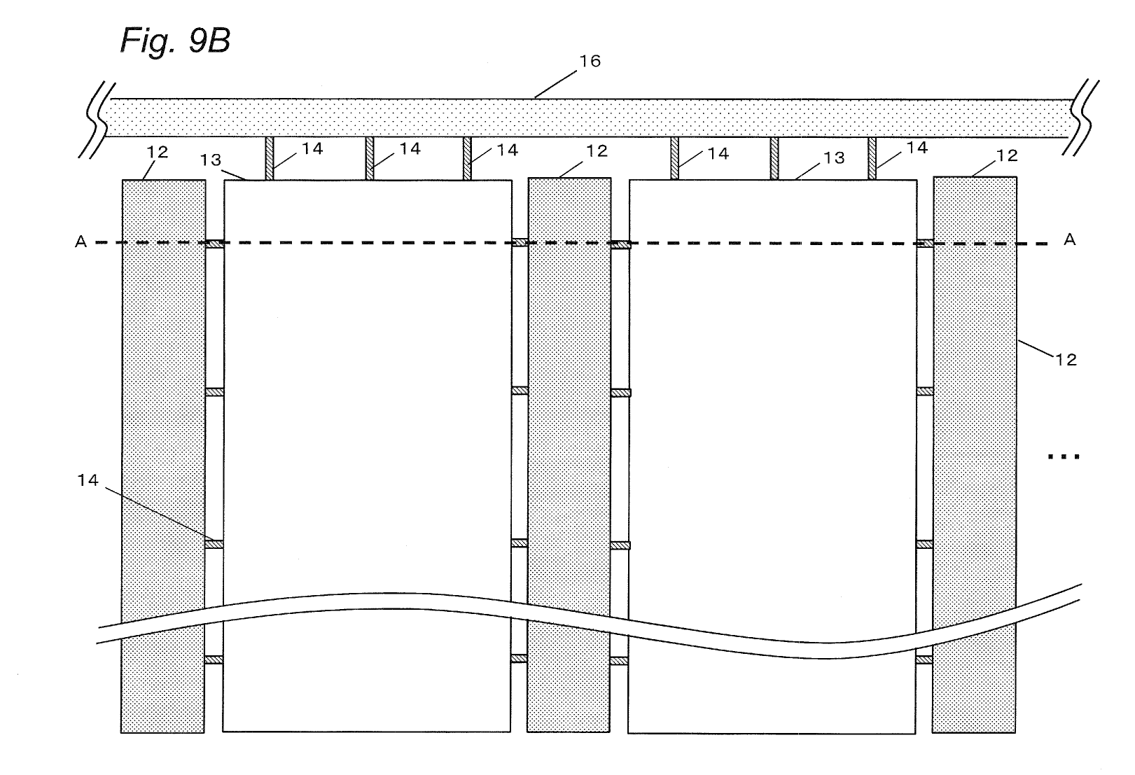

The detection electrode 12 of the present embodiment is configured of substantially rectangle-shaped electrode patterns as shown in FIG. 2A. Each of substantially striped detection electrodes 12 is disposed at predetermined spaces as shown in FIG. 9A(a). An electrode pattern (hereinafter referred to as “dummy electrode”) 13 for improving visibility (an example of the third electrode) is disposed between the detection electrodes 12 disposed at the predetermined spaces. Further, a ground electrode 16 is disposed so as to surround the plurality of detection electrodes and dummy electrodes. It should be noted that the ground electrode 16 may be disposed outside the detection electrodes 12 as shown in FIG. 9A(b).

FIG. 9B is a diagram for explaining electric connection between the detection electrode 12 and the dummy electrode 13.

It is to be noted that in each of drawings of the present embodiment (and other embodiments), only part of the electrode structure is shown for convenience of description.

As shown in FIG. 9B, the dummy electrode 13 is disposed between each of the substantially rectangle-shaped detection electrodes 12. Each dummy electrode 13 is connected to the ground electrode 16 with at least one first connection section 14. Further, each dummy electrode 13 is connected with the adjacent detection electrode 12 with at least one first connection section 14. The first connection section 14 is formed of a high-resistance conductive material.

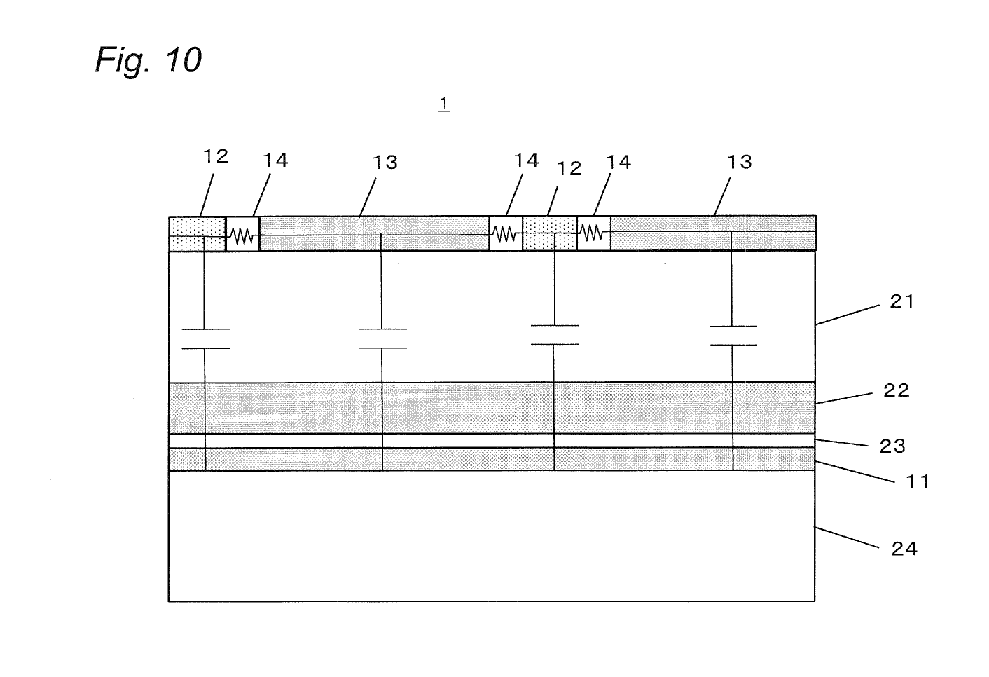

FIG. 10 is a sectional view cut along a line A-A of FIG. 9B. FIG. 10 illustrates a part of the cross section cut along the line As shown in FIG. 10, the liquid crystal panel 1 is configured by filling a liquid crystal layer 22 in a space between a TFT substrate 24 and a color filter 21 which are disposed at the space. The driving electrode 11 is disposed on the TFT substrate 24, and an insulating layer 23 is provided between the driving electrode 11 and the liquid crystal layer 22. The detection electrodes 12 are disposed at the predetermined spaces on the color filter 21. Input of an electric signal and detection of a response thereto by means of a change in capacitance is performed between the driving electrode 11 and the detection electrode 12, to detect contact or approach of an object (e.g., finger) with the display surface. The dummy electrode 13 is disposed between the adjacent detection electrodes 12. The detection electrode 12 and the dummy electrode 13 are connected by the first connection section 14 as a conductor. As shown in FIG. 10, the detection electrode 12, the electrode 13 and the first connection section 14 are formed in the same layer. The detection electrode 12, the electrode 13 and the first connection section 14 may be formed of the same conductive material, or different conductive materials. As these materials, transparent conductive materials such as indium tin oxide (ITO), indium zinc oxide (IZO) and a high polymer may be used.

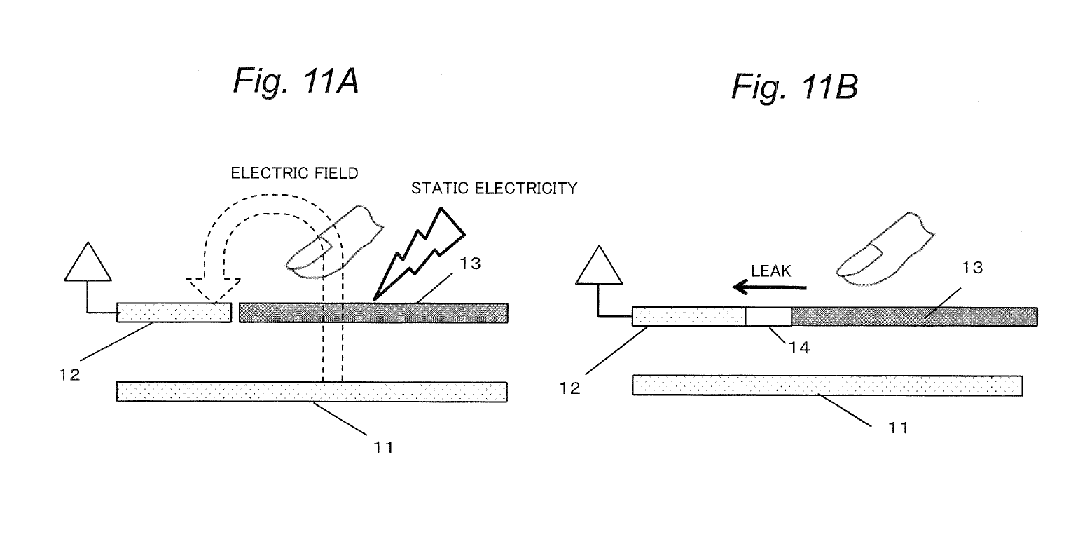

FIG. 11 is a diagram for explaining an electric field generated between the driving electrode 11 and the dummy electrode 13.

FIG. 11A shows a state of the electric field where the electrode 13 and the detection electrode 12 are not connected with the first connection section 14. As shown in FIG. 11A, the electric field exists between the driving electrode 11 and the detection electrode 12. A finger approaching within a range influenced by the electric field, a change in capacitance between the driving electrode 11 and the detection electrode 12 occurs. Since the dummy electrode 13 is generally a floating potential insulated from its periphery, when static electricity is generated, electric charges are accumulated in the dummy electrode 13 to cause disturbance in display of a liquid crystal display, which is problematic.

In contrast, in the liquid crystal display device 100 of the present embodiment, as shown in FIG. 11B, the dummy electrode 13 is electrically connected to the detection electrode 12 or the ground electrode 16 set to a fixed potential via the first connection section 14. Herewith, electric charges accumulated in the dummy electrode 13 at the time of generation of static electricity can be leaked to the ground electrode 16, so as to prevent disturbance in display of the liquid crystal display due to the static electricity. Further, the resistance value of the first connection section 14 is set to high resistance. This makes a time constant of the first connection section 14 large. Accordingly, the first connection section 14 acts as a conductor to be a leak path in a long time interval which influence the display (it is perceivable by human eyes), and acts as almost an insulator in a short time interval for which a touch is detected. Hence it is possible to leak electric charges accumulated in the dummy electrode 13 without causing deterioration in touch detection accuracy.

Here, the resistance value of the first connection section 14 will be described. Table 1 shows the relation among the resistance value of the first connection section 14, a touch sensitivity and resistance to static electricity.

TABLE 1

| | Resistance Value (Ω) | | | | | | |
|---|---|---|---|---|---|---|---|
| | 10 k | 100 k | 1 M | 10 M | 100 M | 1 G | 10 G |
| Touch Sensitivity | NG | NG | OK | OK | OK | OK | OK |
| (37 db or higher) | | | | | | | |
| Resistance to | OK | OK | OK | OK | OK | OK | NG |
| Static Electricity | | | | | | | |
| (display unevenness | | | | | | | |
| on application of | | | | | | | |
| 15 kV) | | | | | | | |

Table 1 shows the display unevenness when applying static electricity of 15 kV, on conditions that the touch sensitivity is 37 db or higher and the resistance to static electricity is 100 pF±10% and 1 kΩ±10%. With reference to Table 1, it is found that preferable performance is obtained when the resistance value of the first connection section 14 is not lower than 1 MΩ and not higher than 1 GΩ.

As described above, in the first embodiment, the electrode 13 is disposed so as to fill a space between the detection electrodes 12, as the second electrodes, capacitively coupled with the driving electrodes 11 as the first electrodes. Further the first connection section is provided which electrically connects the electrode 13 and the electrode set to a predetermined (fixed) potential at high resistance of not lower than 1 MΩ. Further, it is desirable that the resistance value of the first connection section is not higher than 1 GΩ.

With the above configuration, it is possible to release electric charges charged in the electrode 13 without adding of a conductive layer, so as to take measures against static electricity of the display device. Further, the connection at high resistance does not adversely affect an electric field for touch detection, and thus deterioration in touch detection accuracy can be suppressed.

Here, the electrode set to a predetermined potential may be the ground electrode 16 or the detection electrode 12, or both of them.

Hereinafter, a modified example in the first embodiment will be described.

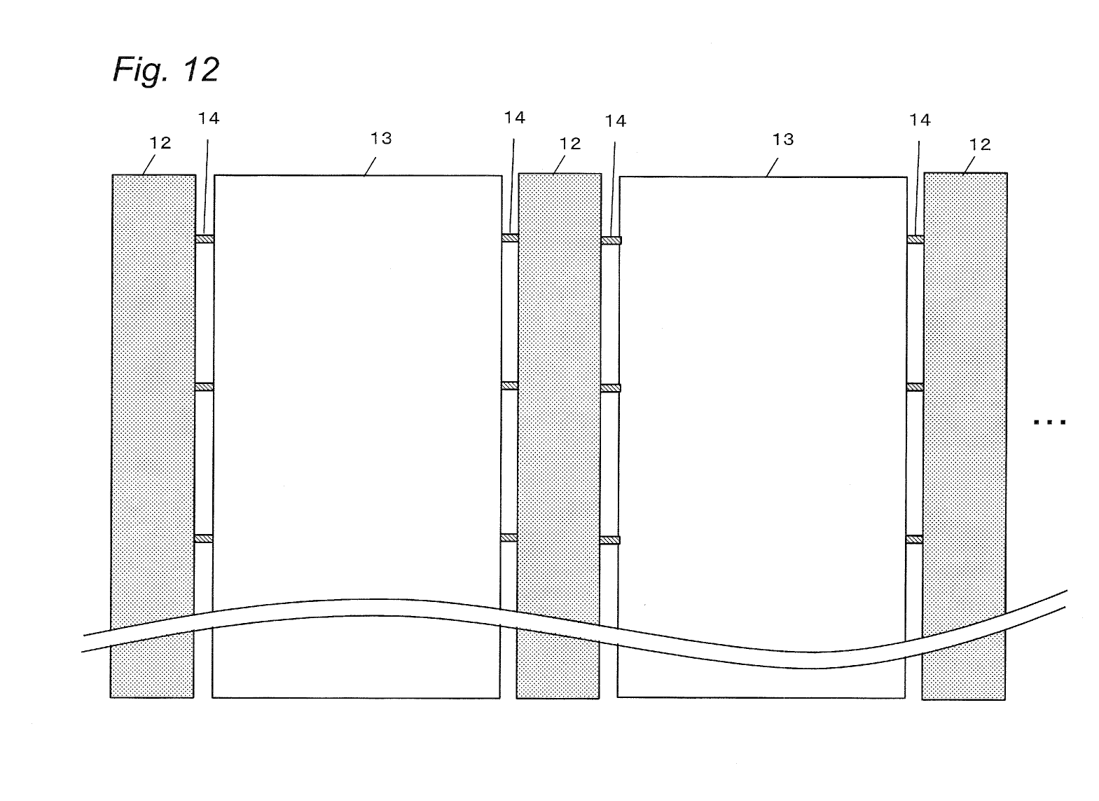

FIG. 12 is a view showing another example of the arrangement pattern of the dummy electrodes 13 and the first connection sections 14 in the touch sensor. In the example of FIG. 12, only the dummy electrode 13 and the detection electrode 12 are connected by the first connection section 14. Here, the number of first connection sections 14 for connecting the electrode 13 and the detection electrode 12 is any number so long as being one or larger.

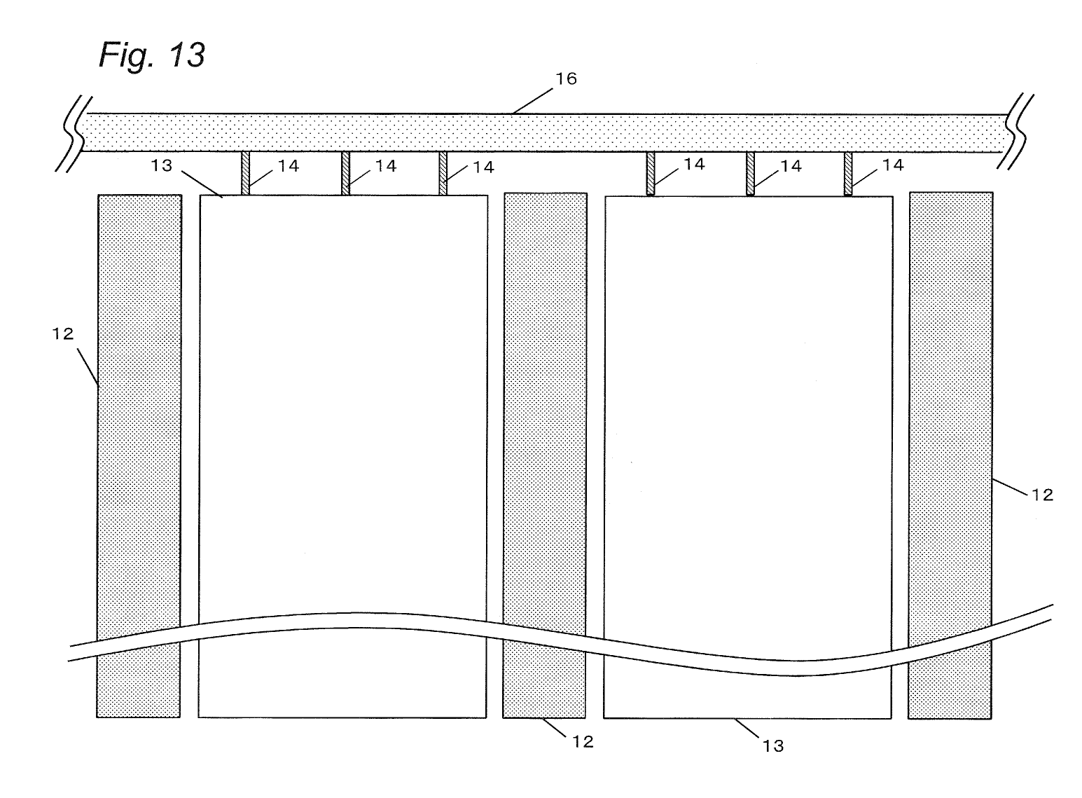

FIG. 13 is a view showing another example of the arrangement pattern of the dummy electrodes 13 and the first connection sections 14 in the touch sensor. In the example of FIG. 13, only the dummy electrode 13 and the ground electrode 16 are connected by the first connection section 14. Here, the number of connection sections 14 to connect the dummy electrode 13 and the ground electrode 16 is any number so long as being one or larger. In the case of the configuration shown in FIG. 13, it is possible to leak static electricity charged in the dummy electrode to the ground electrode 16. However, the connection between the driving electrode 11 and the detection electrode 12 is cut off, and thus the touch detection accuracy may deteriorate as compared to the configurations shown in FIGS. 9B and 12.

### 1-4. Summary

As described above, the liquid crystal panel 1 (an example of the input device) of the present embodiment is an input device having a touch sensor function, and includes: a plurality of driving electrodes 11 (an example of the first electrodes); a plurality of detection electrodes 12 (an example of the second electrodes) which are disposed facing the plurality of driving electrodes 11 to output detection signals based on a touch operation, each detection electrode 12 coupled capacitively with the driving electrode 11; a plurality of dummy electrodes 13 (an example of the third electrodes) each disposed in a region between adjacent detection electrodes 12; and a plurality of first connection sections 14 which have a resistance value not lower than 1 MΩ and electrically connect the plurality of dummy electrodes 13 to a predetermined electrode set to a predetermined potential (e.g., the ground electrode 16 or the detection electrode 12).

By connecting the dummy electrode 13 to the predetermined potential at high resistance as thus described, it is possible to leak electric charges charged in the dummy electrode 13 without causing deterioration in touch detection accuracy. Hence it is possible to prevent disturbance of display on a liquid crystal display due to charging of static electricity without causing deterioration in touch detection accuracy.

The liquid crystal display device 100 includes the display unit which updates a display by applying scanning signals to a plurality of scanning signal lines in one frame period (constitutional element(s) which serves as a display function in the liquid crystal panel 1), and the input device which detects a touched position in a period synchronous with the updating of the display (a constitutional element(s) which serves as a touch sensor function in the liquid crystal panel 1).

### Second Embodiment

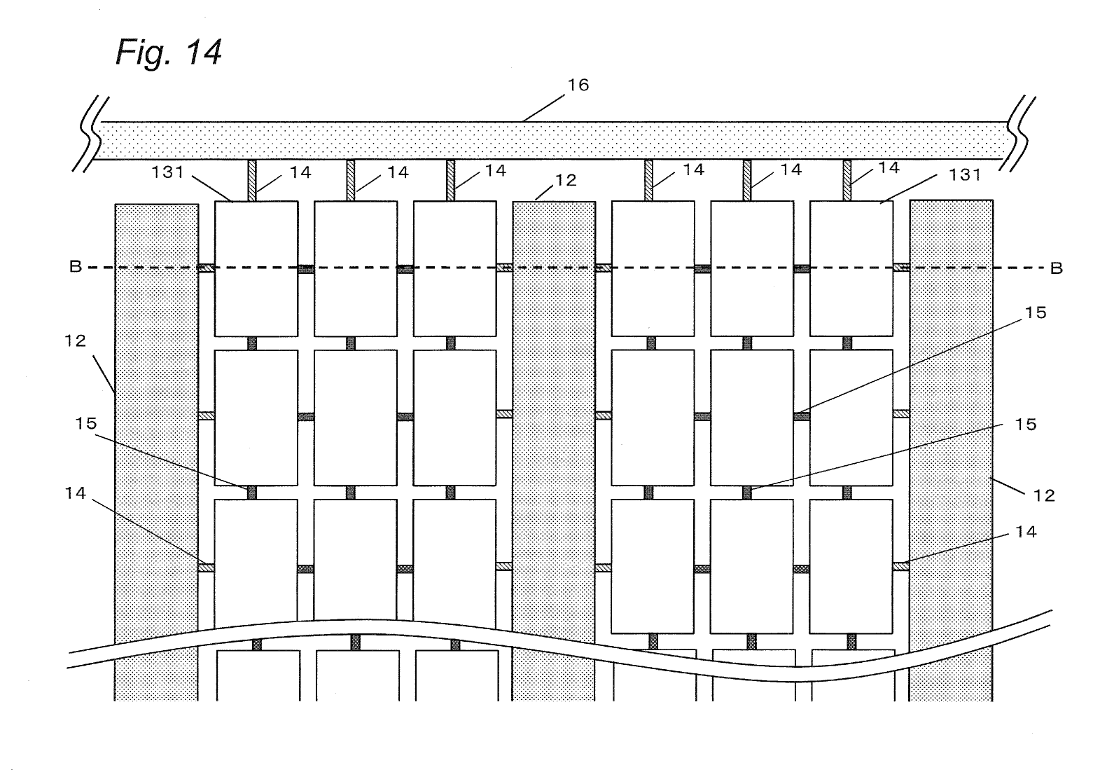

FIG. 14 is a view showing an example of an arrangement pattern of the dumpy electrodes and the connection sections in a touch sensor of a liquid crystal display device according to a second embodiment.

In the present embodiment, as shown in FIG. 14, a plurality of dummy electrodes 131 are disposed at predetermined spaces between the detection electrodes 12. In the dummy electrodes 131, the dummy electrode 131 adjacent to the ground electrode 16 or the detection electrode 12 is connected to the ground electrode 16 or the detection electrode 12 by the first connection section 14. Further, a second connection section 15 is connected between the adjacent dummy electrodes 131. By dividing the dummy electrode into a plurality of small dummy electrodes and disposing them as thus described, the dummy electrodes become difficult to see, thereby allowing improvement in visibility of the liquid crystal panel 1.

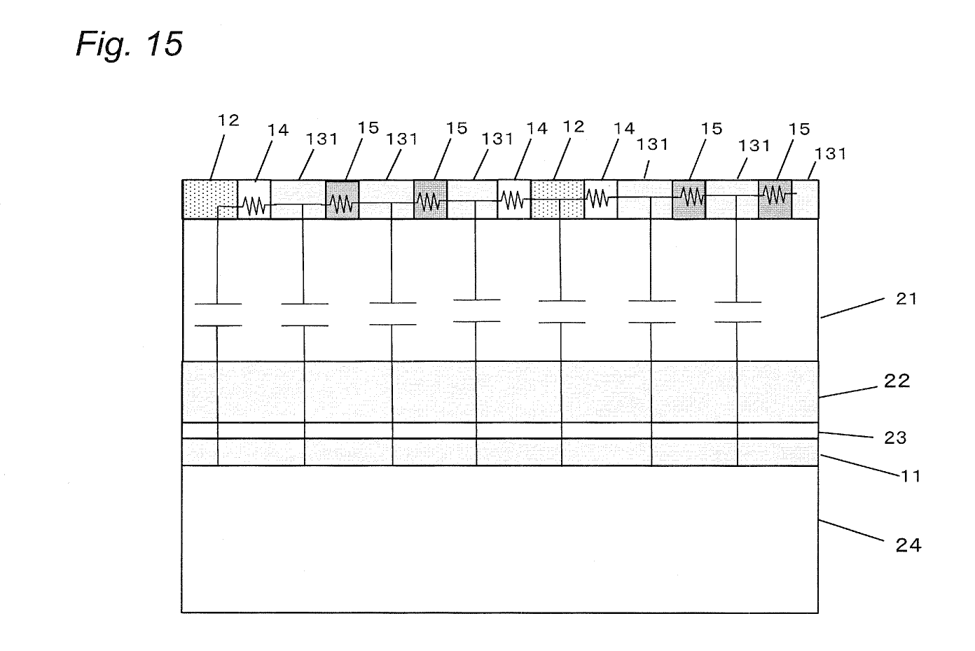

FIG. 15 is a sectional view cut along a line B-B of FIG. 14. FIG. 14 illustrates a part of the cross section cut along the line B-B. Here, a configuration shown in FIG. 15 is the same as the configuration shown in FIG. 10 except for arrangement of the dummy electrodes and the first and second electrodes 14 and 15, and hence arrangement of the dummy electrodes 131 and the first and second electrodes 14 and 15 will be described below.

As shown in FIG. 15, the detection electrodes 12 are disposed at predetermined spaces on the color filter 21, and a plurality of dummy electrodes 131 are disposed between the adjacent detection electrodes 12. The detection electrode 12 and the dummy electrode 131 are connected by the first connection section 14 at high resistance. The adjacent dummy electrodes 131 are connected by the second connection section 15. The driving electrode 11 and the detection electrode 12 are capacitively coupled, and electric charges are accumulated therebetween. The dummy electrode 131 and the driving electrode 11 are also capacitively coupled, and electric charges are accumulated therebetween.

As shown in FIG. 15, the detection electrode 12, the dummy electrode 131, the first connection section 14 and the second connection section 15 are formed in the same layer. The detection electrode 12, the dummy electrode 131, the first connection section 14 and the second connection section 15 may be formed of the same conductive material, or may be formed of mutually different conductive materials. As these materials, there can be used transparent conductive materials such as indium tin oxide (ITO), indium zinc oxide (IZO) and a high polymer.

According to this configuration, electric charges accumulated in the dummy electrode 131 flow to the detection electrode 12 or the ground electrode 16 via the first connection section 14 and the second connection section 15. For this reason, even static electricity is generated, disturbance in display of a display does not occur.

Also in the present embodiment, the resistance value of the first connection section 14 is preferably not lower than 1 MΩ as in the first embodiment. Further, the resistance value of the first connection section 14 is preferably not higher than 1 GΩ. Moreover, the resistance value of the first connection section 14 may be a value higher than a resistance value of the second connection section 15. This can further facilitate releasing of the accumulated electric charges to the detection electrode 12 or the ground electrode 16.

As described above, in the second embodiment, a plurality of dummy electrodes 131 are disposed so as to fill a space between detection electrodes 12 (second electrode) each capacitively coupled with the driving electrode 11 (first electrode). Further, each dummy electrode 131 and the electrode set to a fixed potential are electrically connected with high resistance (e.g., not lower than 1 MΩ) by the first connection section 14. Moreover, a plurality of dummy electrodes 131 are electrically connected by the second connection section 15. The resistance value of the second connection section 15 may be not higher than 1 MΩ.

As described in the above first and second embodiments, forming the detection electrodes 12, the dummy electrodes 131 and the first and second electrodes 14 and 15 in the same layer allows measures against static electricity of the display device to be taken without additional conductive layer. Further, the dummy electrode 131 is connected to the electrode (detection electrode 12, ground electrode 16) set to a predetermined (fixed) potential with high resistance, thereby to suppress deterioration in touch detection accuracy.

Here, as the electrode set to a predetermined potential, either the ground electrode 16 or the detection electrode 12, or both of them, may be used.

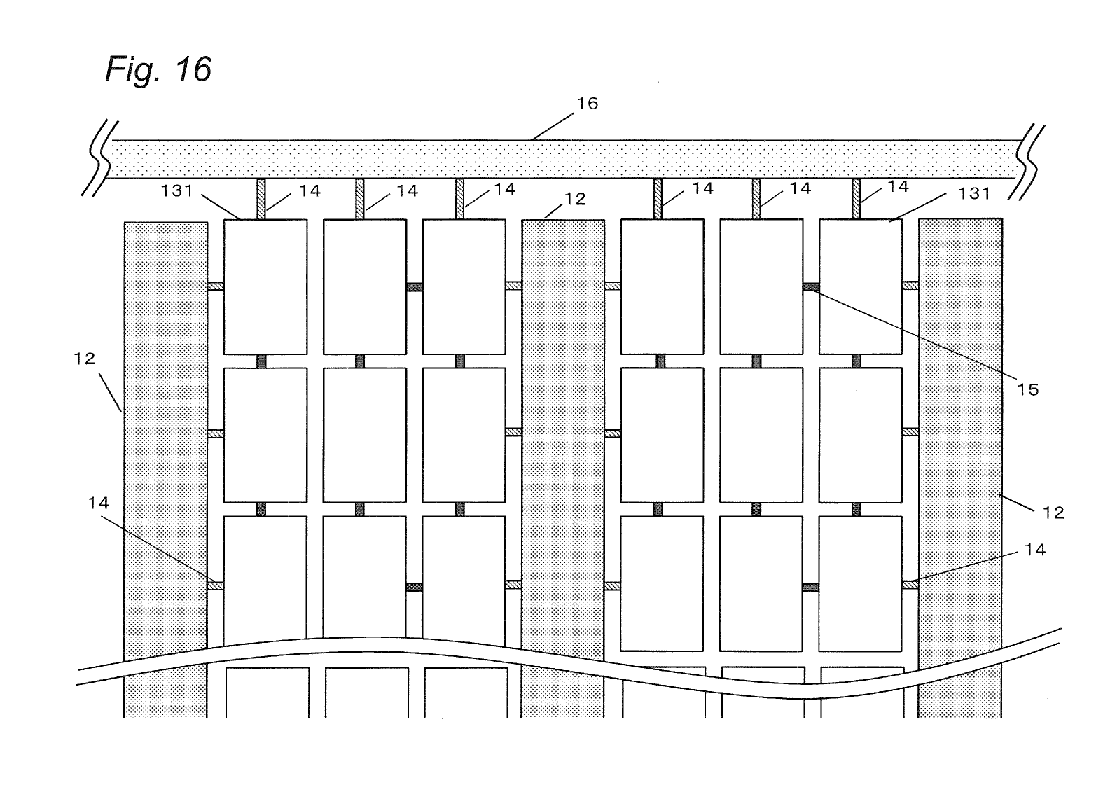

It should be noted that the dummy electrode 131 may be finally electrically coupled to the ground electrode 16 or the detection electrode 12, and is not necessarily required to be connected to its adjacent electrode. For example, as shown in FIG. 16, the dummy electrode 131 may not necessarily be connected to the adjacent dummy electrode 131, the adjacent detection electrode 12 or the adjacent ground electrode 16, so long as the dummy electrode 131 is finally electrically coupled to the ground electrode 16 or the detection electrode 12.

The number of dummy electrodes 131 disposed between the adjacent detection electrodes 12 shown in the present embodiment is illustrative, and the number is not restricted to the number shown in FIGS. 14 and 16.

### Other Embodiments

As described above, the first and second embodiments have been described as the illustrations of the technique disclosed in the present application. However, the technique in the present disclosure is not restricted to these, and is applicable to an embodiment where a change, replacement, addition, omission or the like has been performed as appropriate. Further, a new embodiment can be given by combining each of the constituent elements described in the above first and second embodiments. Accordingly, other embodiments will be illustrated below.

In the first and second embodiments, the time constant of the first connection section 14 may be set not lower than a time constant of the capacitance generated between the driving electrode 11 and the detection electrode 12. For example, the time constant of the first connection section 14 may be preferably set ten times as large as or larger than the time constant of the driving electrode 11 and the detection electrode 12. It may be further preferably set 100 times as large or larger.

### INDUSTRIAL APPLICABILITY

The present disclosure is a useful in a display device having a capacitive touch panel input function.

What is claimed is:

1. An input device having a touch sensor function, comprising:
a plurality of first electrodes;
a plurality of second electrodes which are disposed facing the plurality of first electrodes, each second electrode coupled capacitively with the first electrode to output a detection signal based on a touch operation;
a plurality of third electrodes each disposed in a region between adjacent second electrodes; and
a plurality of first connection sections which have a resistance value not lower than 1 MΩ, and electrically connect the plurality of third electrodes to a predetermined electrode set to a predetermined potential.

2. The input device according to claim 1, wherein a resistance value of the first connection section is not higher than 1 GΩ.

3. The input device according to claim 1, wherein the predetermined electrode is the second electrode.

4. The input device according to claim 1, wherein the predetermined electrode is an electrode which is disposed surrounding the second electrode, and provides a ground potential.

5. The input device according to claim 1, wherein
each third electrode is composed of a plurality of electrodes spaced at predetermined distance, and
second connection sections for connecting the plurality of electrodes composing the third electrode to each other are further provided.

6. The input device according to claim 1, wherein the second electrode, the third electrode and the first connection section are formed in the same layer.

7. The input device according to claim 6, wherein the second electrode, the third electrode and the first connection section are formed of conductive material.

8. The input device according to claim 1, wherein a time constant of the first connection section is not smaller than a time constant of a capacitor formed between the first electrode and the second electrode.

9. A display device comprising:
a display unit configured to update a display by applying scanning signals to a plurality of scanning signal lines in one frame period; and
an input device according to claim 1 which detects a touched position in a period synchronous with the updating of the display.
